(19) United States
(12) Patent Application Publication
(10) Pub. No.: US 2014/0036207 A1
(43) Pub. Date: Feb. 6, 2014

(54) LIQUID CRYSTAL DISPLAY PANEL

(71) Applicant: HANNSTAR DISPLAY CORPORATION, New Taipei City (TW)

(72) Inventors: Chia-Hua Yu, New Taipei City (TW); I-Fang Wang, Changhua County (TW); Kun-Cheng Lee, Tainan City (TW); Feng-Wei Kuo, Pingtung County (TW)

(73) Assignee: HANNSTAR DISPLAY CORPORATION, New Taipei City (TW)

(21) Appl. No.: 13/759,065

(22) Filed: Feb. 5, 2013

(30) Foreign Application Priority Data
Aug. 2, 2012 (CN) 201210273586.X

(51) Int. Cl. G02F 1/1335

(52) U.S. Cl. CPC G02F 1/133512
USPC 349/106; 349/110

(57) ABSTRACT

An LCD panel including an active device array substrate (ADA substrate), an opposite substrate, a black matrix pattern, a liquid crystal layer (LC layer), a first alignment layer and multiple spacers is provided. The black matrix pattern is disposed on the opposite substrate and has multiple first and second bar-shape patterns. The first alignment layer is disposed between the ADA substrate or opposite substrate and the LC layer. A rubbing direction of the first alignment layer is parallel to the extension direction of the first bar-shape patterns. The spacers are disposed between the first alignment layer and the ADA substrate or opposite substrate. The orthogonal projections of the spacers and the first bar-shape patterns on the ADA substrate are overlapped with each other, and the orthogonal projections of multiple rubbing dragging traces surrounding the spacers and the corresponding first bar-shape patterns on the ADA substrate are overlapped with each other.

### CROSS-REFERENCE TO RELATED APPLICATION

This application claims the priority benefit of China application serial no. 201210273586.X, filed on Aug. 2, 2012. The entirety of the above-mentioned patent application is hereby incorporated by reference herein and made a part of this specification.

### BACKGROUND OF THE INVENTION

1. Field of the Invention

The invention generally relates to a display panel, and more particularly, to a liquid crystal display panel (LCD panel).

2. Description of Related Art

On the market for thin-film transistor liquid crystal display (TFT-LCDs) currently, the TFT-LCDs are towards the direction of high contrast, no grayscale inversion, high luminance, high color saturation, fast response and wide viewing angle. The common wide viewing angle technology includes: twisted nematic liquid crystal (TN liquid crystal) with wide viewing angle film, in-plane switching LCD (IPS LCD), fringe field switching LCD (FFS LCD) and multi-domain vertical alignment LCD (MVA LCD).

For the IPS LCD and the FFS LCD panel, it is usually composed of an active device array substrate, a color filter substrate disposed on the active device array substrate, and a liquid crystal layer, an alignment layer and a plurality of spacers for supporting and maintaining a gap between the active device array substrate and the color filter substrate disposed therebetween, in which the active device array substrate is formed by an active device array disposed on the inner surface of a first substrate, while the active device array includes a plurality of pixel electrodes and a common electrode. The color filter substrate is formed by a color filter patterns disposed on the inner surface of a second substrate.

The function of the alignment layer is mainly to provide the liquid crystal molecules with a stable boundary condition so that the liquid crystal molecules are arranged along a specific sequential direction, in which the alignment layer is normally processed through multiple rubbings so that the liquid crystal molecules of the liquid crystal layer obtain a polydirectional effect. In general speaking, the alignment rubbing processing is a fabrication technology for rubbing alignment from a side edge of the substrate up by using a rubbing roller. During conducting the rubbing processing from a side edge of the substrate up by the rubbing roller however, due to the thickness of the spacers, rubbing dragging traces are produced around the spacers, which makes the frame of the LCD panel have mura phenomena to affect the displaying quality of the LCD panel and the problem needs to be solved.

### SUMMARY OF THE INVENTION

Accordingly, the invention is directed to an LCD panel with better displaying quality.

In order to solve the above-mentioned problem, the invention provides an LCD panel which includes: an active device array substrate, an opposite substrate, a black matrix pattern, a liquid crystal layer, a first alignment layer and a plurality of spacers. The opposite substrate is disposed opposite to the active device array substrate. The black matrix pattern is disposed on the opposite substrate and located between the active device array substrate and the opposite substrate, in which the black matrix pattern has a plurality of first bar-shape patterns and a plurality of second bar-shape patterns, and the first bar-shape patterns and the second bar-shape patterns are perpendicularly intersected by each other. The liquid crystal layer is disposed between the active device array substrate and the opposite substrate. The first alignment layer is disposed between the active device array substrate and the liquid crystal layer or between the opposite substrate and the liquid crystal layer, in which a rubbing direction of the first alignment layer is parallel to an extension direction of the first bar-shape patterns of the black matrix pattern. The spacers are disposed between the first alignment layer and the active device array substrate or between the first alignment layer and the opposite substrate, in which the orthogonal projections of the spacers and the first bar-shape patterns of the black matrix pattern on the active device array substrate are overlapped with each other, and the orthogonal projections of a plurality of rubbing dragging traces surrounding the spacers and the corresponding first bar-shape patterns of the black matrix pattern on the active device array substrate are overlapped with each other.

In an embodiment of the present invention, the above-mentioned active device array substrate includes a first substrate, a plurality of data lines, a plurality of scan lines and a plurality of pixel units. The data lines are disposed on the first substrate. The orthogonal projections of the first bar-shape patterns of the black matrix pattern and the data lines on the active device array substrate are overlapped with each other. The scan lines are disposed on the first substrate. The orthogonal projections of the second bar-shape patterns of the black matrix pattern and the scan lines on the active device array substrate are overlapped with each other. The pixel units are disposed on the first substrate, in which each of the pixel units is electrically connected to a corresponding scan line and a corresponding data line.

In an embodiment of the present invention, the width of each of the above-mentioned first bar-shape patterns is greater than or equal to the width of each of the data lines.

In an embodiment of the present invention, the width of each of the above-mentioned second bar-shape patterns is greater than or equal to the width of each of the scan lines.

In an embodiment of the present invention, the above-mentioned first alignment layer is disposed between the active device array substrate and the liquid crystal layer, the spacers are disposed between the first alignment layer and the opposite substrate, and the spacers are disposed on the active device array substrate.

In an embodiment of the present invention, the above-mentioned LCD panel further includes a second alignment layer disposed between the opposite substrate and the liquid crystal layer, and the spacers are disposed between the first alignment layer and the second alignment layer.

In an embodiment of the present invention, the above-mentioned first alignment layer is disposed between the opposite substrate and the liquid crystal layer, the spacers are disposed between the first alignment layer and the active device array substrate, and the spacers are located on the opposite substrate.

In an embodiment of the present invention, the above-mentioned LCD panel further includes a second alignment layer disposed between the active device array substrate and the liquid crystal layer, and the spacers are disposed between the first alignment layer and the second alignment layer.

In an embodiment of the present invention, the above-mentioned LCD panel further includes a plurality of color filter patterns disposed on the opposite substrate, in which the first bar-shape patterns and the second bar-shape patterns of the black matrix pattern define a plurality of openings and the color filter patterns are located in the openings.

In an embodiment of the present invention, the ratio of the diameter of each of the above-mentioned spacers over the width of each of the first bar-shape patterns of the black matrix pattern ranges between 0.5 and 1.

Based on the description above, in the invention, the orthogonal projections of the spacers and the first bar-shape patterns of the black matrix pattern on the active device array substrate are overlapped with each other, and the orthogonal projections of the rubbing dragging traces surrounding the spacers and the corresponding first bar-shape patterns of the black matrix pattern on the active device array substrate are overlapped with each other. That is to say the rubbing dragging traces surrounding the spacers produced by the alignment rubbing processing would be shaded by the first bar-shape patterns of the black matrix pattern so that the LCD panel of the invention has better displaying quality.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1A is a partial top-view diagram of an LCD panel according to an embodiment of the invention.

FIG. 1B is a cross-sectional diagram of FIG. 1A along line I-I.

### DESCRIPTION OF THE EMBODIMENTS

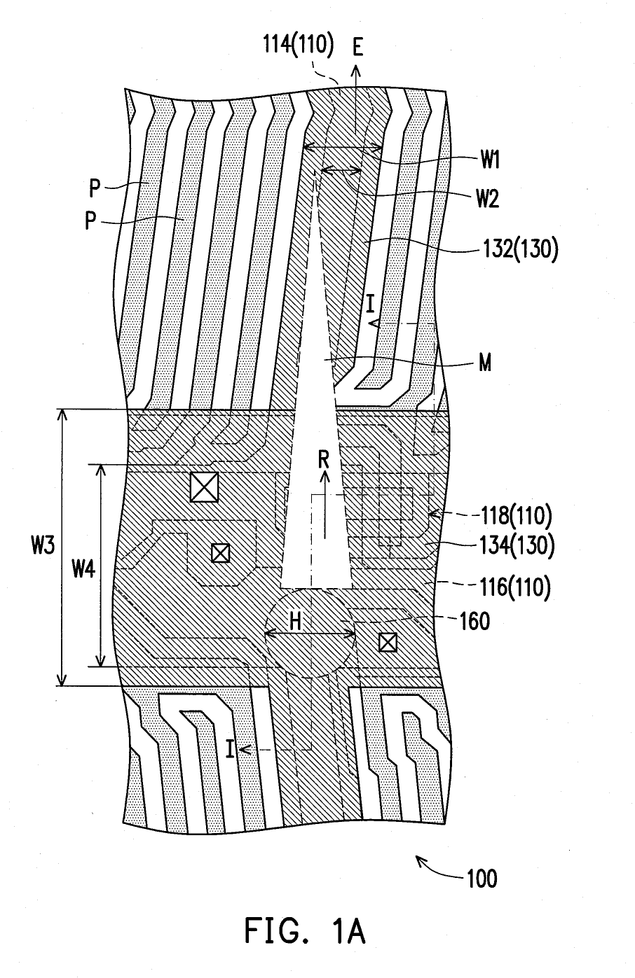

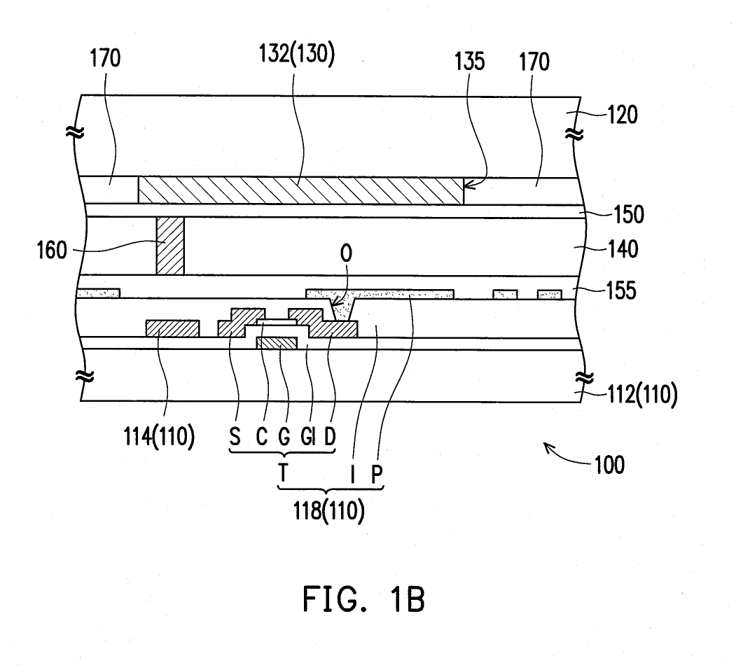

FIG. 1A is a partial top-view diagram of an LCD panel according to an embodiment of the invention and FIG. 1B is a cross-sectional diagram of FIG. 1A along line I-I. For simplicity, some components in FIG. 1A are omitted. Referring to FIGS. 1A and 1B, in the embodiment, the LCD panel 100 includes an active device array substrate 110, an opposite substrate 120, a black matrix pattern 130, a liquid crystal layer 140, a first alignment layer 150 and a plurality of spacers 160 (in FIGS. 1A and 1B, only one separation 160 is shown).

The opposite substrate 120 and the active device array substrate 110 are opposite to each other. The black matrix pattern 130 is disposed on the opposite substrate 120 and located between the active device array substrate 110 and the opposite substrate 120. The black matrix pattern 130 has a plurality of first bar-shape patterns 132 and a plurality of second bar-shape patterns 134, and the first bar-shape patterns 132 and the second bar-shape patterns 134 are perpendicularly intersected by each other. The liquid crystal layer 140 is disposed between the active device array substrate 110 and the opposite substrate 120.

The first alignment layer 150 is disposed between the opposite substrate 120 and the liquid crystal layer 140. In particular, a rubbing direction R of the first alignment layer 150 is parallel to an extension direction E of the first bar-shape patterns 132 of the black matrix pattern 130. The spacers 160 are disposed between the first alignment layer 150 and the active device array substrate 110 and located on the opposite substrate 120. The orthogonal projections of the spacers 160 and the first bar-shape patterns 132 of the black matrix pattern 130 on the active device array substrate 110 are overlapped with each other. Herein, the orthogonal projection of the spacers 160 on the active device array substrate 110 and the orthogonal projection of the perpendicular overlapped place of the first bar-shape patterns 132 and the second bar-shape patterns 134 of the black matrix pattern 130 on the active device array substrate 110 are overlapped with each other. The orthogonal projection of a plurality of rubbing dragging traces M surrounding the spacers 160 (in FIG. 1A, only one is shown) and the corresponding first bar-shape patterns 132 of the black matrix pattern 130 on the active device array substrate 110 are overlapped with each other. Specifically, the ratio of diameter H of each of the spacers 160 over the width W1 of each of the first bar-shape patterns 132 of the black matrix pattern 130 ranges between 0.5 and 1.

In more details, referring to FIGS. 1A and 1B again, the active device array substrate 110 of the embodiment includes a first substrate 112, a plurality of data lines 114, a plurality of scan lines 116 and a plurality of pixel units 118. The data lines 114 are disposed on the first substrate 112, and the orthogonal projections of the first bar-shape patterns 132 of the black matrix pattern 130 and the data lines 114 on the active device array substrate 110 are overlapped with each other. The width W1 of each of the first bar-shape patterns 132 is, for example, greater than or equal to the width W2 of each of the data lines 114. The scan lines 116 are disposed on the first substrate 112. The orthogonal projections of the second bar-shape patterns 134 of the black matrix pattern 130 and the scan lines 116 on the active device array substrate 110 are overlapped with each other. The width W3 of each of the second bar-shape patterns 134 is, for example, greater than or equal to the width W4 of each of the scan lines 116. The pixel units 118 are disposed on the first substrate 112, and each of the pixel units 118 is electrically connected to the corresponding scan line 116 and the corresponding data line 114. Each of the pixel units 118 is composed of a gate G, a gate insulation layer GI, a semiconductor channel layer C, a source S, a drain D, an insulation layer I and a pixel electrode P. The insulation layer I herein has an opening O exposing a portion of the drain D, and the pixel electrode P is electrically connected to the drain D via the opening O. The gate G, the gate insulation layer GI, the semiconductor channel layer C, the source S and the drain D together form a thin film transistor T, in which the thin film transistor T is, for example, a top-gate thin film transistor, the pixel electrode P is, for example, a fork-shape electrode, and the pixel electrode P is made of, for example, transparent conductive material.

The LCD panel 100 in the embodiment further includes a second alignment layer 155, in which the second alignment layer 155 is disposed between the active device array substrate 110 and the liquid crystal layer 140, and the spacers 160 are located between the first alignment layer 150 and the second alignment layer 155. In addition, to enable the LCD panel 100 displaying color frames, the LCD panel 100 can further include a plurality of color filter patterns 170, in which the color filter patterns 170 are disposed on the opposite substrate 120, the first bar-shape patterns 132 and the second bar-shape patterns 134 of the black matrix pattern 130 define a plurality of openings 135, and the color filter patterns 170 are located in the openings 135.

Since the orthogonal projections of the spacers 160 and the first bar-shape patterns 132 of the black matrix pattern 130 on the active device array substrate 110 are overlapped with each other and the rubbing direction R of the first alignment layer 150 is parallel to the extension direction E of the first bar-shape patterns 132 of the black matrix pattern 130, the orthogonal projection of the rubbing dragging traces M surrounding the spacers 160 and the corresponding first bar-shape patterns 132 of the black matrix pattern 130 on the active device array substrate 110 are overlapped with each other. As a result, the first bar-shape patterns 132 of the black matrix pattern 130 can effectively shade the rubbing dragging traces M produced during the alignment rubbing processing due to disposing the spacers 160, and thus the mura phenomena are unlikely produced on the displaying frames of the LCD panel 100 and the embodiment can achieve better displaying quality of the LCD panel 100.

It should be noted that the invention does not limit the disposing positions of the first alignment layer 150, the second alignment layer 155 and the spacers 160. In fact, although in the embodiment, the first alignment layer 150 is disposed between the opposite substrate 120 and the liquid crystal layer 140, the second alignment layer 155 is disposed between the active device array substrate 110 and the liquid crystal layer 140 and the spacers 160 are disposed on the opposite substrate 120 and between the first alignment layer 150 and the second alignment layer 155, but in other unshown embodiments, the first alignment layer 150 can be disposed between the active device array substrate 110 and the liquid crystal layer 140, the second alignment layer 155 can be disposed between the opposite substrate 120 and the liquid crystal layer 140 and the spacers 160 can be disposed on the active device array substrate 110 and between the first alignment layer 150 and the second alignment layer 155 as well, which still falls in the scope protected by the invention as an feasible layout.

In summary, in the invention, the orthogonal projections of the spacers and the first bar-shape patterns of the black matrix pattern on the active device array substrate are overlapped with each other, and the orthogonal projection of the rubbing dragging traces surrounding the spacers and the corresponding first bar-shape patterns of the black matrix pattern on the active device array substrate are overlapped with each other. That is to say the rubbing dragging traces surrounding the spacers produced by the alignment rubbing processing would be shaded by the first bar-shape patterns of the black matrix pattern so that the LCD panel of the invention has better displaying quality.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. A liquid crystal display panel, comprising:
an active device array substrate;
an opposite substrate, disposed opposite to the active device array substrate;
a black matrix pattern, disposed on the opposite substrate and located between the active device array substrate and the opposite substrate, wherein the black matrix pattern has a plurality of first bar-shape patterns and a plurality of second bar-shape patterns, and the first bar-shape patterns and the second bar-shape patterns are perpendicularly intersected by each other;
a liquid crystal layer, disposed between the active device array substrate and the opposite substrate;
a first alignment layer, disposed between the active device array substrate and the liquid crystal layer or between the opposite substrate and the liquid crystal layer, wherein a rubbing direction of the first alignment layer is parallel to an extension direction of the first bar-shape patterns of the black matrix pattern; and
a plurality of spacers, disposed between the first alignment layer and the active device array substrate or between the first alignment layer and the opposite substrate, wherein orthogonal projections of the spacers and the first bar-shape patterns of the black matrix pattern on the active device array substrate are overlapped with each other, and orthogonal projections of a plurality of rubbing dragging traces surrounding the spacers and the corresponding first bar-shape patterns of the black matrix pattern on the active device array substrate are overlapped with each other.

2. The liquid crystal display panel as claimed in claim 1, wherein the active device array substrate comprises:
a first substrate;
a plurality of data lines, disposed on the first substrate, wherein orthogonal projections of the first bar-shape patterns of the black matrix pattern and the data lines on the active device array substrate are overlapped with each other;
a plurality of scan lines, disposed on the first substrate, wherein orthogonal projections of the second bar-shape patterns of the black matrix pattern and the scan lines on the active device array substrate are overlapped with each other; and
a plurality of pixel units, disposed on the first substrate, wherein each of the pixel units is electrically connected to a corresponding scan line and a corresponding data line.

3. The liquid crystal display panel as claimed in claim 2, wherein width of each of the first bar-shape patterns is greater than or equal to width of each of the data lines.

4. The liquid crystal display panel as claimed in claim 2, wherein width of each of the second bar-shape patterns is greater than or equal to width of each of the scan lines.

5. The liquid crystal display panel as claimed in claim 1, wherein the first alignment layer is disposed between the active device array substrate and the liquid crystal layer, the spacers are disposed between the first alignment layer and the opposite substrate, and the spacers are disposed on the active device array substrate.

6. The liquid crystal display panel as claimed in claim 5, further comprising a second alignment layer disposed between the opposite substrate and the liquid crystal layer, and the spacers are disposed between the first alignment layer and the second alignment layer.

7. The liquid crystal display panel as claimed in claim 1, wherein the first alignment layer is disposed between the opposite substrate and the liquid crystal layer, the spacers are disposed between the first alignment layer and the active device array substrate, and the spacers are located on the opposite substrate.

8. The liquid crystal display panel as claimed in claim 7, further comprising a second alignment layer disposed between the active device array substrate and the liquid crystal layer, and the spacers are disposed between the first alignment layer and the second alignment layer.

9. The liquid crystal display panel as claimed in claim 1, further comprising a plurality of color filter patterns disposed on the opposite substrate, wherein the first bar-shape patterns and the second bar-shape patterns of the black matrix pattern define a plurality of openings and the color filter patterns are located in the openings.

10. The liquid crystal display panel as claimed in claim 1, wherein ratio of diameter of each of the spacers over width of each of the first bar-shape patterns of the black matrix pattern ranges between 0.5 and 1.
